(19) United States
(12) Patent Application Publication
(10) Pub. No.: US 2007/0111119 A1
(43) Pub. Date: May 17, 2007

(54) Method for repairing gas turbine engine compressor components

(75) Inventors: Yiping Hu, Greer, SC (US); William F. Hehmann, Greer, SC (US); Wen Guo, Greenville, SC (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/280,106

(22) Filed: Nov. 15, 2005

(51) Int. Cl. G03G 15/02

(52) U.S. Cl. 430/57.8

(57) ABSTRACT

A method for repairing an eroded surface of a gas turbine compressor component includes depositing an amorphous alloy onto the eroded surface, melting the amorphous alloy with a laser beam on the eroded surface, and re-solidifying the amorphous alloy to form a welded deposit. The weld is then machined to restore the component to its original dimensions.

### TECHNICAL FIELD

The present invention relates to repair and overhaul of turbine engine components. More particularly, the present invention relates to methods for repairing turbine engine components made from high-strength iron-based alloys.

### BACKGROUND

Turbine engines are used as the primary power source for many types of aircrafts. The engines are also auxiliary power sources that drive air compressors, hydraulic pumps, and industrial gas turbine (IGT) power generation. Further, the power from turbine engines is used for stationary power supplies such as backup electrical generators and the like.

Most turbine engines generally follow the same basic power generation procedure. Compressed air generated by axial and/or radial compressors is mixed with fuel and burned, and the expanding hot combustion gases are directed against stationary turbine vanes in the engine. The vanes turn the high velocity gas flow partially sideways to impinge on the turbine blades mounted on a rotatable turbine disk. The force of the impinging gas causes the turbine disk to spin at high speed. Jet propulsion engines use the power created by the rotating turbine disk to draw more air into the engine and the high velocity combustion gas is passed out of the gas turbine aft end to create forward thrust. Other engines use this power to turn one or more propellers, fans, electrical generators, or other devices.

Low and high pressure compressor (LPC/HPC) components such as compressor blades and impellers are primary components in the cold section for any turbine engine, and should be well maintained. The LPC/HPC components are subjected to stress loadings during turbine engine operation, and may also be impacted by foreign objects such as sand, dirt, and other such debris. The LPC/HPC components can degrade over time due to wear, erosion and foreign object impact. Sometimes LPC/HPC components are degraded to a point at which they may require replacement or repair. Since the replacement may result in significant part expense and time out of service, repair of gas turbine components is often a better option, when possible.

There are several traditional welding methods for repairing damaged turbine engine components, and each method has both advantages and limitations in terms of success. One reason for the lack of success is that the welding techniques and materials used to repair LPC/HPC components may not lend themselves to efficient and/or thorough repairs. For example, precipitation-hardened semiaustenitic stainless steel alloys are commonly used to make compressor blades because these alloys are strong and have good corrosion resistance. However, when repairing compressor blades made of these alloys using conventional welding techniques, such as plasma transferred arc (PTA) welding or tungsten inert gas (TIG) welding, it may be somewhat difficult to control heat inputs and other welding parameters. Limited control in these areas may result in complex or inefficient welding steps in order to reduce or eliminate hot cracking, part distortion, and to minimize the heat-affected zone in the weld and the base material. Also, repairing degraded compressor blades using the same filler as the base material may require relatively complex post-welding process. Furthermore, such a filler typically has a somewhat low hardness, and components that are repaired using such a filler may not perform well during subsequent operation in a sand environment.

Hence, there is a need for new repair methods for LPC/HPC components such as compressor blades. There is a particular need for new and more efficient repair methods that improve the reliability and performance of the repaired components.

### BRIEF SUMMARY

The present invention provides a method for repairing an eroded surface of gas turbine compressor components. An amorphous alloy is deposited onto the eroded surface to fill material loss. First, the amorphous alloy is melted with a laser beam on the eroded surface, and then the molten amorphous alloy is re-solidified to form a welded deposit.

Other independent features and advantages of the preferred methods will become apparent from the following detailed description, taken in conjunction with the accompanying drawings which illustrate, by way of example, the principles of the invention.

### BRIEF DESCRIPTION OF THE DRAWINGS

FIG. 1 is a schematic view of an exemplary laser powder fusion welding apparatus in accordance with an exemplary embodiment;

FIG. 2 is a perspective view of an exemplary compressor blade in accordance with an exemplary embodiment;

FIG. 3 is a perspective view of an exemplary laser powder fusion welding nozzle and a powder nozzle repairing a compressor blade; and

FIG. 4 is a flow diagram of a repair method in accordance with an exemplary embodiment.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention provides an improved method for repairing LPC/HPC components. The method utilizes a laser fusion welding technique to apply materials having tailored features to a worn LPC/HPC component surface. These materials can be used to repair components such as compressor blades and vanes, including impellers and blisks, which have been degraded due to wear, erosion and foreign object damage, to name several examples.

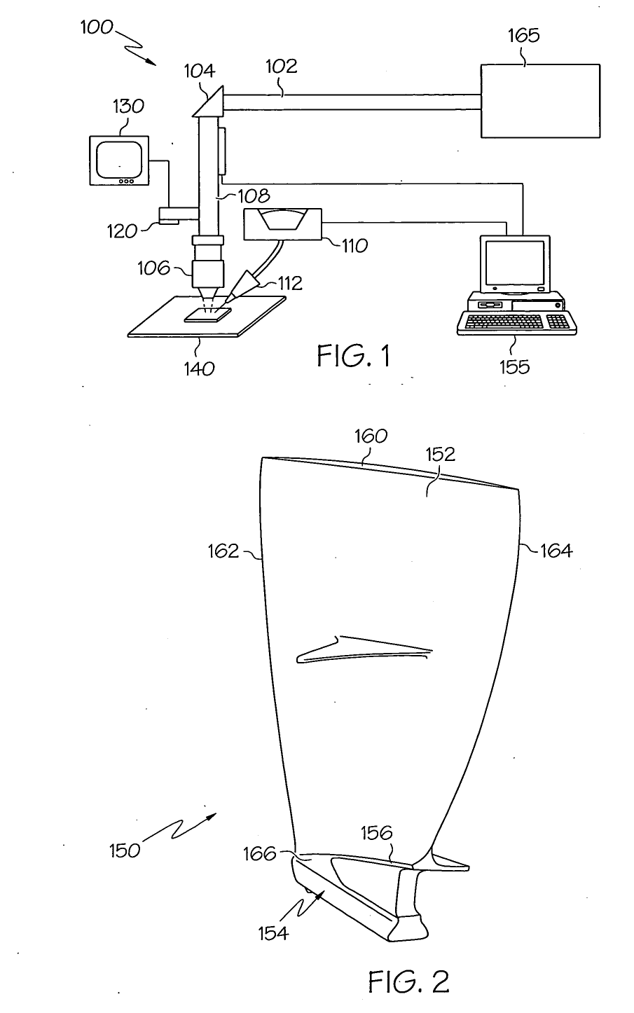

Turning now to FIG. 1, an exemplary laser powder fusion welding system 100 is illustrated schematically. The system 100 is illustrated generally, and additional features and components can be implemented into or removed from the system 100 as necessary or desired. Further, the performance of exemplary welding procedures is not limited to the use of an automated welding system such as that depicted in FIG. 1, but may also be performed using a hand-held laser welding system. The main system components include a laser generator 165, and a laser beam guide or other delivery device 102 through which a laser beam from the laser source 165 is directed. An exemplary beam guide 102 includes fiber optic materials. The laser beam is directed through the beam guide 102 using at least one mirror 104 and a focus lens assembly 106 that is mounted on a laser arm 108 and includes at least one focus lens. The laser beam exits the focus lens assembly 106 and impinges on a damaged component surface that is secured on a work table 140.

A welding metal powder is contained in a powder feeder 110. A powder feed nozzle 112 is in communication with the powder feeder 110 by way of a tube or other suitable conduit through which the metal powder is fed until it exits the powder feed nozzle 112 and reaches the component surface being repaired.

Other exemplary system components include a vision camera 120 and a monitor 130 that aid the system operator in viewing the repair process as performed by the laser beam and the metal powder as they impinge on the component surface being repaired. A controller 155 guides movement of the laser and powder relative to the component surface, preferably by moving the work table 140 at least in the XY plane although relative movement in the Z direction may be performed by raising and lowering either the work table 140 or the laser arm 108. An exemplary controller 155 is a computer numerically controlled (CNC) positioning system that coordinates the system components.

Under the control of the CNC positioning system, the laser is guided across the component surface being repaired while powder from the feeder 110 is directed from the nozzle 112. The laser beam and the powder pathways meet at the component surface where the energy from the laser beam melts the powder. The molten metal reacts with the component surface and then re-solidifies to form a cladding layer, as will be subsequently described in greater detail.

As previously mentioned, the laser fusion welding process can be used to repair a variety of different turbine engine components. For example, the compressor blades in the cold section of a turbine engine are particularly susceptible to wear, erosion and other degradation. Turning now to FIG. 2, a compressor blade 150 that is exemplary of the types that are used in turbine engines is illustrated, although compressor blades commonly have different shapes, dimensions and sizes depending on gas turbine engine models and applications. The blade 150 includes several components that are particularly susceptible to wear, erosion and foreign object damage, and the process of the present invention can be tailored to repair different blade components. Among such blade components is an airfoil 152, which is a smooth, curved structure. The airfoil 152 includes one concave face and one convex face. In operation, air is drawn into the compressor where multiple stages of compressor airfoils act to compress the air in preparation for combustion with some type of fuel. The airfoil 152 includes a leading edge 162 and a trailing edge 164 that encounter air streaming around the airfoil 152. The compressor blade 150 also includes a tip 160. In some applications the tip may include features commonly known as squealers. The compressor blade 150 is mounted on a non-illustrated compressor hub or rotor disk by way of a dovetail 154 that extends downwardly from the airfoil 152 and engages with a slot on the compressor hub. A platform 156 extends longitudinally outwardly from the area where the airfoil 152 is joined to the dovetail 154. Common features on some compressor blades are midspan dampers or snubbers 158, which are typically centrally located on each side of the airfoil 152. The dampers or snubbers 158 extend outwardly to engage with mating features of adjacent compressor or fan blades within the rotor. This engagement makes the dampers or snubbers 158 common wear features that can be repaired according to the method of the present invention. Other compressor configurations include blisks or integrally bladed rotors (IBRs) and impellers or centrifugal compressors, which have blades that are integral to the rotor hub.

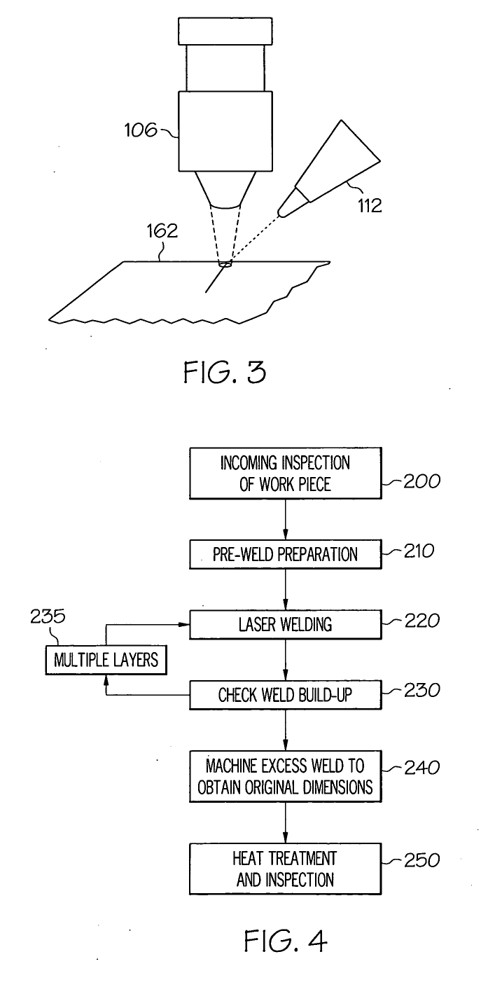

As mentioned previously, the process of the present invention can be tailored to fit the blade's specific needs, which depend in part on the blade component where degradation has occurred. For example, degradation on the leading edge 162 and trailing edge 164 of the airfoil 152 can be repaired using the laser powder fusion welding process. The leading edge 162 and trailing edge 164 are both subject to degradation, again typically due to foreign particle impacts. FIG. 3 is a perspective view of a cracked leading edge 162 being repaired using the previously-described system 100, although this and other welding methods may be performed using a hand-held laser welding system. Further, the welding metal may be applied in a wire form rather than a powder form. For any of these applications, the welding process is used to apply amorphous materials that restore the edges 162 and 164 of the compressor blade 150 to the required dimensions. This can be done by laser depositing amorphous materials onto the worn surface and other defects, followed by a machining process.

As another example, the airfoil tip 160 is particularly subject to degradation due to rubbing and other contact with the static shroud, in addition to foreign particle impacts, and the laser fusion welding process of the present invention is used to apply materials to the blade tip 160 by filling any material loss with amorphous alloys. Following the welding process, the tip 160 is machined to restore the tip 160 to the original design dimensions.

As another example, degradation on the platform 156 can be repaired using the laser fusion welding process. In some applications, wear on the platform 156 occurs at the contact surfaces 166 between adjacent compressor blades. At those locations, the friction can cause fretting and other wear. The laser powder fusion welding process can be used to fill the worn surface, cracks and other defects on the platform to restore the desired dimensions.

Again, the above repair processes are just examples of how a typical compressor blade 150 can be repaired by laser fusion welding according to the present invention. It is also emphasized again that compressor blades are just one example of the type of LPC/HPC components that can be repaired. For example, many gas turbine engines include a shroud structure that surrounds a row of compressor blades at the outer radial end of the blades. The shroud, like the blade tips 160, can be subject to erosion and repaired using the welding process. Other turbine engine components that can be repaired in such a manner include compressor stator vanes, vane support structures, rotor nozzles and other LPC/HPC components.

Turning now to FIG. 4, the steps for an exemplary method 200 for repairing turbine components are illustrated as a block diagram. This method includes the laser powder fusion welding process described above, and also includes additional optional processes to optimize the resulting repairs. A suitable workpiece is identified as step 200. Although the preceding discussion is primarily focused on LPC/HPC components such as compressor blades and vanes, any worn workpiece may potentially be inspected and determined as suitable components for repair using the present laser fusion repair method. The method is particularly useful for repairing stainless steel surfaces. In an exemplary method the workpiece surface is formed from semiaustenitic stainless steel such as AM-350™ and AM-355™. AM-350™ is an iron-based alloy, and further includes by weight about 16 to 17% Cr, 4 to 5% Ni, 2.5 to 3.25% Mo, 0.5 to 1.25% Mn, 0.07 to 0.13% N, 0.07 to 0.11% C, 0 to 0.5% Si, 0 to 0.04% P, and 0 to 0.03% S. AM-355™ is also an iron-based alloy and further includes by weight the same elements and concentrations as AM-350™ but with slightly less Cr (about 15 to 16%) and slightly more C (about 0.1 to 0.15%).

After selecting a suitable and repairable workpiece for repair, any necessary pre-welding procedures are performed to prepare the worn surface for laser powder fusion welding. An exemplary pre-welding procedure includes cleaning, machining and grit blasting the repair surface as step 210, although other pre-welding procedures may also be included in step 210. Grit blasting removes contaminants that interfere with laser powder fusion welding, and improves laser energy absorption.

Next, laser powder fusion welding is performed as step 220 using any suitable laser fusion welding apparatus. One exemplary welding apparatus is a handheld laser welding device such as that disclosed in U.S. Pat. No. 6,593,540 assigned to Honeywell International, Inc. Another exemplary welding apparatus is the automated laser welding device depicted in FIG. 1. Yet another exemplary welding apparatus deposits amorphous alloy from a weld wire and a powder. Further, there are various types of lasers suitable for an exemplary laser fusion welding procedure, including an yttrium aluminum garnet (YAG) laser that may include a dopant such as neodymium, or a direct diode, fiber, or carbon dioxide laser.

During laser fusion welding, the laser preferably has a power output of at least about 50 watts. The laser beam is directed onto the surface to be repaired and an amorphous alloy is fed onto the surface in the laser beam path. Energy from the laser beam melts the amorphous filler material. After the laser beam is moved from a molten pool, the molten filler material cools and re-solidifies to form a weld. Welding parameters such as laser power output, amorphous material feed rate, traverse speed, and shield gas flow rate may be manipulated to eliminate or minimize hot cracking on the workpiece and to otherwise optimize the weld formed on the workpiece surface.

The amorphous alloy that is fed onto the repair surface and melted by the laser beam energy can be selected based on various factors including the repair surface material, the normal operating environment for the component being repaired, and the needed metallurgical requirements for the weld. Amorphous powders and weld wires are just two forms which are suitable for laser powder fusion welding to repair eroded surfaces. An amorphous alloy is glass-like in structure, lacking a crystalline lattice. Amorphous alloys have certain advantages over conventional alloys. For example, amorphous alloys are capable of exhibiting high yield strength. Also, the absence of grain boundaries in amorphous alloys typically provides more resistance to corrosion than polycrystalline materials. Further, many amorphous alloys having fine boride distributions are more resistant to wear than polycrystalline materials due to their high hardness.

One example of a suitable amorphous alloy for repair of many iron-based substrates such as stainless steels, including semiaustenitic stainless steels, is developed and produced under the trademark LMC-M™ from Liquidmetal Technologies and has a nominal composition, in weight percent, of 44.5% Cr, 5.9% B, 2.0% Si, 0.17% C, balance Fe. Another suitable amorphous alloy for repair of many iron-based substrates such as stainless steels, including semiaustenitic stainless steels, is sold under the mark LMC-C from Liquidmetal Technologies and has a nominal composition, in weight percent, of 30% Cr, 19% Ni, 9.7% Co, 3.9% Mo, 3.5% B, 2.5% Cu, 1.3% Si, 0.12% C, balance Fe.

After completing a weld, the repaired surface is examined as step 230 for suitable weld buildup. Additional amorphous filler material may be needed to provide adequate buildup to the component surface. Further, excess filler will later be ground or otherwise machined from the component surface, so it may be desirable to have a minimum amount of excess weld at the point of repair. If it is determined at step 235 that at least one additional layer of weld is needed, the method returns to step 220 for additional laser fusion welding of amorphous material to the repair surface.

After amorphous alloys are laser deposited onto eroded surfaces of compressor components to provide adequate material buildup for machining, as step 240, the excess weld from the repair area is ground or otherwise machined to restore the component to its original dimensions. During machining, the weld transforms at its surface from a two-phase crystalline materials to a homogeneous amorphous structure. In addition to having high yield strength and corrosion resistance, the high transformed surface hardness provides excellent wear resistance while bulk hardness remains at a level to provide a tough support structure. In this way, repaired compressor components will perform well in a sand operational environment.

The repaired workpiece may be heat treated as step 250 to relieve welding stress while avoiding crystal growth. In an exemplary embodiment, the repaired workpiece is heat treated at a temperature of between approximately 800 to approximately 1425° F. for about 1 hour. Subsequently, the repaired workpiece may be inspected, for example, by a fluorescent penetration inspection (FPI), to determine whether it can be returned to service.

The present invention thus provides an improved method for repairing and prolonging the service life of turbine engine components such as compressor blades and other compressor components. The method utilizes a laser powder fusion welding technique to repair degradation in compressor components such as blades, impellers, blisks, and the like. These methods can be effectively used to repair eroded compressor components, and thus can improve the overall durability, reliability and performance of gas turbine engines.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for repairing an eroded surface of a gas turbine compressor component, the method comprising:
depositing an amorphous alloy onto the eroded surface, the eroded surface comprising an iron-based alloy;
melting the amorphous alloy with a laser beam on the eroded surface; and
re-solidifying the amorphous alloy to form a welded deposit.

2. The method of claim 1, further comprising:
machining the welded deposit to restore the metal surface to predetermined contours.

3. The method of claim 1, wherein the amorphous alloy is an iron-based alloy.

4. The method of claim 3, wherein the iron-based amorphous alloy comprises chromium, boron, silicon, and carbon.

5. The method of claim 3, wherein the amorphous alloy is selected from the group consisting of a first alloy consisting essentially of 44.5% Cr, 5.9% B, 2.0% Si, 0.17% C, balance Fe, and a second alloy consisting essentially of 30% Cr, 19% Ni, 9.7% Co, 3.9% Mo, 3.5% B, 2.5% Cu, 1.3% Si, 0.12% C, balance Fe.

6. The method of claim 1, wherein the metal surface comprises stainless steel.

7. The method of claim 6, wherein the metal surface comprises semiaustenitic stainless steel.

8. The method of claim 1, wherein the amorphous alloy is deposited as a powder onto the metal surface.

9. The method of claim 1, wherein the amorphous alloy is deposited from a wire onto the metal surface.

10. A method for repairing a metal surface of a turbine compressor component, the method comprising:
depositing an amorphous alloy onto the metal surface, the metal surface comprising a stainless steel alloy;
melting the amorphous alloy with a laser beam on the metal surface;
re-solidifying the amorphous alloy to form a welded deposit; and
machining the welded deposit to restore the metal surface to predetermined contours, and to transform the welded region to have a substantially homogenous amorphous structure.

11. The method of claim 10, wherein the amorphous alloy is an iron-based alloy.

12. The method of claim 11, wherein the iron-based amorphous alloy comprises chromium, boron, silicon, and carbon.

13. The method of claim 11, wherein the amorphous alloy is selected from the group consisting of a first alloy consisting essentially of 44.5% Cr, 5.9% B, 2.0% Si, 0.17% C, balance Fe, and a second alloy consisting essentially of 30% Cr, 19% Ni, 9.7% Co, 3.9% Mo, 3.5% B, 2.5% Cu, 1.3% Si, 0.12% C, balance Fe.

14. The method of claim 10, wherein the metal surface comprises semiaustenitic stainless steel.

15. The method of claim 10, wherein the amorphous alloy is deposited as a powder onto the metal surface.

16. The method of claim 10, wherein the amorphous alloy is deposited from a wire onto the metal surface.

17. A method for repairing a metal surface of a turbine compressor component, the method comprising:
depositing an amorphous iron-based alloy comprising chromium, boron, silicon, and carbon onto the metal surface, the metal surface comprising a semiaustenitic stainless steel alloy;
melting the amorphous alloy with a laser beam on the metal surface;
re-solidifying the amorphous alloy to form a welded deposit; and
machining the welded deposit to restore the metal surface to predetermined contours, and to transform the welded region to have a substantially homogenous amorphous structure.

18. The method of claim 17, wherein the amorphous alloy is selected from the group consisting of a first alloy consisting essentially of 44.5% Cr, 5.9% B, 2.0% Si, 0.17% C, balance Fe, and a second alloy consisting essentially of 30% Cr, 19% Ni, 9.7% Co, 3.9% Mo, 3.5% B, 2.5% Cu, 1.3% Si, 0.12% C, balance Fe.

19. The method of claim 17, wherein the amorphous alloy is deposited as a powder onto the metal surface.

20. The method of claim 17, wherein the amorphous alloy is deposited from a wire onto the metal surface.
